(19) United States
(12) Patent Application Publication
(10) Pub. No.: US 2025/0050906 A1
(43) Pub. Date: Feb. 13, 2025

(54) Autonomous Driving Control Apparatus and Method Thereof

(71) Applicants: Hyundai Motor Company, Seoul (KR); Kia Corporation, Seoul (KR)

(72) Inventors: Keon Chang Lee, Hwaseong-Si (KR); Yong Suk kang, Seoul (KR); Chang Young jung, Seoul (KR); Dong Hwi Lee, Seongnam-si (KR)

(21) Appl. No.: 18/772,442

(22) Filed: Jul. 15, 2024

(30) Foreign Application Priority Data
Aug. 10, 2023 (KR) 10-2023-0104998

(51) Int. Cl. B60W 60/00; G01C 21/34; G06V 20/56

(52) U.S. Cl. CPC B60W 60/001; G01C 21/34; G06V 20/588

(57) ABSTRACT

Disclosed is an autonomous driving control apparatus which includes a sensor device, a memory, and a controller. For example, the autonomous driving control apparatus may determine at least one lane detection result regarding a lane in which a host vehicle is traveling, using at least one of a first sensor included in a sensor device or a second sensor included in the sensor device, or any combination thereof, generate at least one driving route, based on the at least one lane detection result, and determine a final driving route for autonomous driving of the host vehicle, based on the at least one driving route.

### CROSS-REFERENCE TO RELATED APPLICATION

This application claims the benefit of priority to Korean Patent Application No. 10-2023-0104998, filed in the Korean Intellectual Property Office on Aug. 10, 2023, the entire contents of which are incorporated herein by reference.

### TECHNICAL FIELD

The present disclosure relates to an autonomous driving control apparatus and a method thereof, and more particularly, relates to technologies of identifying a driving route for autonomous driving control for a host vehicle based on information obtained using different types of sensors.

### BACKGROUND

For example, the autonomous driving may be divided into partial autonomous driving, conditional autonomous driving, high autonomous driving, and/or full autonomous driving depending on its control level.

Meanwhile, various types of control algorithms (or functions) for controlling driving of a host vehicle among autonomous driving control functions have been developed.

For example, an autonomous driving control apparatus may perform various driving functions, such as smart cruise control capable of controlling longitudinal movement of a vehicle while maintaining driving on the lane, highway driving assist, and a lane keeping assist system for providing a user with a warning or returning a host vehicle to a line in which the host vehicle is traveling when the host vehicle deviates from the line in which the host vehicle is traveling.

Particularly, being required by the above-mentioned function may be a technology for recognizing a line in which the host vehicle is traveling. The line may be recognized from an image for the forward direction of an autonomous vehicle.

In general, the autonomous driving control apparatus may obtain at least one image about an area including a forward direction of the host vehicle using a sensor (e.g., a camera) mounted on one area of a wind shield (e.g., a front glass) of the host vehicle.

Furthermore, the autonomous driving control apparatus may obtain at least one image about an area including the sideward direction of the host vehicle using a side mirror (or a side view mirror).

However, at least one image including a line which is present in a relatively remote distance may be obtained by means of a camera mounted close to the wind shield in a situation where there is no obstacle in front of the host vehicle, but at least one image in which a line is covered by an obstacle may be obtained in a situation where there is the obstacle to reduce the accuracy of control of the autonomous driving control apparatus.

In addition, the camera mounted on the wind shield is relatively reduced in recognition performance, when a curvature of a lane in which the host vehicle is traveling is high.

Furthermore, a camera mounted on a side mirror may identify the recognized result of relatively high accuracy even on a lane with a high curvature, regardless of whether there is an obstacle in front of the host vehicle. However, due to the characteristics of the camera, a recognition distance (or coverage) may be short, curvature information corresponding to a driving direction of the host vehicle may be recognized relatively late, and there may be a distortion in the result of recognizing a line.

### SUMMARY

The present disclosure has been made to solve the above-mentioned problems occurring in the prior art while advantages achieved by the prior art are maintained intact.

An aspect of the present disclosure provides an autonomous driving control apparatus for identifying at least one lane detection result about a lane in which a host vehicle is traveling, using a sensor device including different types of sensors.

Another aspect of the present disclosure provides an autonomous driving control apparatus for generating at least one driving route using each of at least one lane detection result and identifying a final driving route for autonomous driving of a host vehicle based on at least one of reliability of each of the generated at least one driving route, a similarity between the at least one driving route, a curvature of an estimated lane, or any combination thereof.

Another aspect of the present disclosure provides an autonomous driving control apparatus for adaptively applying a scheme for generating a final driving route, based on whether reliability of each of different types of sensors is greater than or equal to reference reliability.

Another aspect of the present disclosure provides an autonomous driving control apparatus for dividing the case in which lines included in lane detection results respectively recognized by different types of sensors correspond to different lines or the case in which the lines correspond to the same lines and selectively applying one of a plurality of schemes for generating the final driving route.

Another aspect of the present disclosure provides an autonomous driving control apparatus for identifying route information corresponding to a virtual driving route generated based on a lane detection result. Another aspect of the present disclosure provides an autonomous driving control apparatus for identifying an equation included in route information, may identify a curvature and a heading of each of driving routes identified based on at least one coefficient of the equation, and may identify a similarity between the driving routes using the identified result.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an autonomous driving control apparatus may include a sensor device including a first sensor and a second sensor different from the first sensor, a memory storing at least one instruction, and a controller operatively connected with the sensor device and the memory. For example, the at least one instruction may be configured to, when executed by the controller, cause the autonomous driving control apparatus to determine at least one lane detection result regarding a lane in which a host vehicle is traveling, using at least one of the first sensor or the second sensor, or any combination thereof, generate at least one driving route, based on the at least one lane detection result, and determine a final driving route for autonomous driving of the host vehicle, based on the at least one driving route.

According to an embodiment, the sensor device may include the first sensor that determines a first lane detection result about an area including a forward direction of the host vehicle and includes at least one first camera mounted on at least one area of a wind shield of the host vehicle and the second sensor that determines a second lane detection result about an area including a sideward direction of the host vehicle and includes at least one second camera mounted on at least one area of a side mirror of the host vehicle.

According to an embodiment, the at least one instruction may be configured to, when executed by the controller, cause the autonomous driving control apparatus to determine the first lane detection result using the first sensor and determine the second lane detection result using the second sensor, generate a first driving route and a second driving route, based respectively on the first lane detection result and the second lane detection result, and generate the final driving route based on at least one of a similarity value between the first driving route and the second driving route, first reliability value for the first driving route, or second reliability value for the second driving route, or any combination thereof.

According to an embodiment, the at least one instruction may be configured to, when executed by the controller, cause the autonomous driving control apparatus to determine the first reliability value of the first driving route and the second reliability value of the second driving route, generate the final driving route based on the first driving route, when the first reliability value is greater than or equal to reference reliability value, and generate the final driving route based on the second driving route, when the first reliability value is less than the reference reliability value and when the second reliability value is greater than or equal to the reference reliability value.

According to an embodiment, the at least one instruction may be configured to, when executed by the controller, cause the autonomous driving control apparatus to, when a first line included in the first lane detection result corresponds to a line in an opposite direction to a second line included in the second lane detection result, determine the first reliability value of the first driving route and the second reliability value of the second driving route, determine a similarity value between the first driving route and the second driving route, when the first reliability value and the second reliability value are greater than or equal to reference reliability value, and generate the final driving route including information about the first line and the second line based on the first driving route and the second driving route, when the similarity value is greater than or equal to the reference similarity value.

According to an embodiment, the at least one instruction may be configured to, when executed by the controller, cause the autonomous driving control apparatus to, when a first line included in the first lane detection result corresponds to a line in an opposite direction to a second line included in the second lane detection result, determine the first reliability value of the first driving route and the second reliability value of the second driving route, determine a similarity value between the first driving route and the second driving route, when the first reliability value and the second reliability value are greater than or equal to reference reliability value, and generate the final driving route including information about the first line and the second line based on a driving route with a low curvature between the first driving route and the second driving route, when the similarity value is less than the reference similarity value.

According to an embodiment, the at least one instruction may be configured to, when executed by the controller, cause the autonomous driving control apparatus to, when a first line included in the first lane detection result corresponds to a line in an opposite direction to a second line included in the second lane detection result, determine the first reliability value of the first driving route and the second reliability value of the second driving route and generate the final driving route including information about the first line and the second line based on a driving route corresponding to reliability value with a higher value between the first reliability value and the second reliability value.

According to an embodiment, the at least one instruction may be configured to, when executed by the controller, cause the autonomous driving control apparatus to, when a first line included in the first lane detection result corresponds to a line in the same direction as a second line included in the second lane detection result, determine the first reliability value of the first driving route and the second reliability value of the second driving route, determine a similarity value between the first driving route and the second driving route, when the first reliability value and the second reliability value are greater than or equal to reference reliability value, and generate the final driving route including information about the first line and the second line based on at least one piece of route information (e.g., an average of a first equation coefficient and at least one second equation coefficient corresponding to the second driving route) corresponding to the first driving route, when the similarity value is greater than or equal to the reference similarity value.

According to an embodiment, the at least one instruction may be configured to, when executed by the controller, cause the autonomous driving control apparatus to, when a first line included in the first lane detection result corresponds to a line in the same direction as a second line included in the second lane detection result, determine the first reliability value of the first driving route and the second reliability value of the second driving route, determine a similarity value between the first driving route and the second driving route, when the first reliability value and the second reliability value are greater than or equal to reference reliability value, and generate the final driving route including information about the first line and the second line based on a driving route with a low curvature between the first driving route and the second driving route, when the similarity value is less than the reference similarity value.

According to an embodiment, the at least one instruction may be configured to, when executed by the controller, cause the autonomous driving control apparatus to control the host vehicle to travel based on the first driving route identified using the first sensor, before the host vehicle enters a section with a curvature of a specified value or more, when determining that the host vehicle is expected to enter the section and that the first reliability value of the first driving route and the second reliability value of the second driving route are greater than or equal to reference reliability value, based on an estimated driving route of the host vehicle.

According to an embodiment, the at least one instruction may be configured to, when executed by the controller, cause the autonomous driving control apparatus to control the host vehicle to travel based on the second driving route when accuracy of curvature information included in the first lane detection result is less than reference accuracy, while the host vehicle enters the section.

According to an embodiment, the at least one instruction may be configured to, when executed by the controller, cause the autonomous driving control apparatus to determine the similarity value between the first driving route and the second driving route, after the host vehicle completes entering the section, and generate the final driving route based on the first driving route, when the similarity value meets a specified criterion.

According to an embodiment, the at least one instruction may be configured to, when executed by the controller, cause the autonomous driving control apparatus to generate a first driving route and a second driving route, based respectively on the first lane detection result and the second lane detection result, determine at least one piece of route information corresponding to the first driving route, determine a similarity value between the first driving route and the second driving route based on whether a difference between the at least one piece of route information is greater than a threshold, and generate the final driving route based further on the similarity value.

According to an embodiment, the at least one instruction may be configured to, when executed by the controller, cause the autonomous driving control apparatus to determine location information of a control target point, based on a driving vehicle speed of the host vehicle and an estimated driving time to the control target point, and determine the similarity value between the first driving route and the second driving route, based on at least one of a first curvature of the first driving route, a first heading of the first driving route, a second curvature of the second driving route, or a second heading of the second driving route, or any combination thereof, the first curvature, the first heading, the second curvature, and the second heading being identified on the basis of the location information.

According to an embodiment, the at least one instruction may be configured to, when executed by the controller, cause the autonomous driving control apparatus to determine that the similarity value between the first driving route and the second driving route is greater than or equal to reference similarity value, when a difference between the first curvature and the second curvature is less than a reference curvature difference and when a difference between the first heading and the second heading is less than a reference heading difference.

According to another aspect of the present disclosure, an autonomous driving control method may include determining, by a controller, at least one lane detection result regarding a lane in which a host vehicle is traveling, using at least one of a first sensor included in a sensor device or a second sensor included in the sensor device, or any combination thereof, generating, by the controller, at least one driving route, based on the at least one lane detection result, and determining, by the controller, a final driving route for autonomous driving of the host vehicle, based on the at least one driving route.

According to an embodiment, the autonomous driving control method may further include generating, by the controller, a first driving route based on a first lane detection result identified using the first sensor and generating, by the controller, a second driving route based on a second lane detection result identified using the second sensor, determining, by the controller, first reliability value of the first driving route and second reliability value of the second driving route, generating, by the controller, the final driving route based on the first driving route, when the first reliability value is greater than or equal to reference reliability value, and generating, by the controller, the final driving route based on the second driving route, when the first reliability value is less than the reference reliability value and when the second reliability value is greater than or equal to the reference reliability value.

According to an embodiment, the autonomous driving control method may further include generating, by the controller, a first driving route based on a first lane detection result identified using the first sensor and generating, by the controller, a second driving route based on a second lane detection result identified using the second sensor, determining, by the controller, first reliability of the first driving route and second reliability of the second driving route, when a first line included in the first lane detection result corresponds to a line in an opposite direction to a second line included in the second lane detection result, determining, by the controller, a similarity value between the first driving route and the second driving route, when the first reliability value and the second reliability value are greater than or equal to reference reliability value, and generating, by the controller, the final driving route including information about the first line and the second line based on a driving route with a low curvature between the first driving route and the second driving route, when the similarity value is less than the reference similarity value.

According to an embodiment, the autonomous driving control method may further include generating, by the controller, a first driving route based on a first lane detection result identified using the first sensor and generating, by the controller, a second driving route based on a second lane detection result identified using the second sensor, determining, by the controller, first reliability value of the first driving route and second reliability value of the second driving route, when a first line included in the first lane detection result corresponds to a line in the same direction as a second line included in the second lane detection result, determining, by the controller, a similarity value between the first driving route and the second driving route, when the first reliability value and the second reliability value are greater than or equal to reference reliability value, and generating the final driving route including information about the first line and the second line based on a driving route with a low curvature between the first driving route and the second driving route, when the similarity value is less than the reference similarity value.

According to an embodiment, the autonomous driving control method may further include generating, by the controller, a first driving route based on a first lane detection result identified using the first sensor and generating, by the controller, a second driving route based on a second lane detection result identified using the second sensor, and when determining, by the controller, that the host vehicle is expected to enter a section with a curvature of a specified value or more and that first reliability value of the first driving route and second reliability value of the second driving route are greater than or equal to reference reliability value, based on an expected driving route of the host vehicle, controlling, by the controller, the host vehicle to travel based on the first driving route identified using the first sensor, before the host vehicle enters the section, controlling, by the controller, the host vehicle to travel based on the second driving route, when accuracy of curvature information included in the first lane detection result is less than reference accuracy, while the host vehicle enters the section, and determining, by the controller, a similarity value between the first driving route and the second driving route, after the host vehicle completes entering the section, and generating, by the controller, the final driving route based on the first driving route, when the similarity value meets specified criterion.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating components of an autonomous driving control apparatus according to an embodiment of the present disclosure;

FIG. 2 is a flowchart of an autonomous driving control method according to an embodiment of the present disclosure;

FIG. 3 is a flowchart of an autonomous driving control method according to an embodiment of the present disclosure;

FIG. 4 is a flowchart of an autonomous driving control method according to an embodiment of the present disclosure;

FIG. 5 is a flowchart of an autonomous driving control method according to an embodiment of the present disclosure;

FIG. 6 is a flowchart of an autonomous driving control method according to an embodiment of the present disclosure;

FIG. 7 is an operational conceptual diagram of an autonomous driving control apparatus according to an embodiment of the present disclosure;

FIG. 8A is an operational conceptual diagram of an autonomous driving control apparatus according to an embodiment of the present disclosure;

FIG. 8B is an operational conceptual diagram of an autonomous driving control apparatus according to an embodiment of the present disclosure;

FIG. 8C is an operational conceptual diagram of an autonomous driving control apparatus according to an embodiment of the present disclosure;

FIG. 9 is a flowchart of an autonomous driving control method according to an embodiment of the present disclosure; and

FIG. 10 illustrates a computing system about an autonomous driving control method according to an embodiment of the present disclosure.

With regard to description of drawings, the same or similar denotations may be used for the same or similar components.

### DETAILED DESCRIPTION

Hereinafter, some embodiments of the present disclosure will be described in detail with reference to the exemplary drawings. In the drawings, the same reference numerals will be used throughout to designate the same or equivalent components. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this invention belongs. It will be understood that terms used herein should be interpreted as having a meaning that is consistent with their meaning in the context of this disclosure and the relevant art and will not be interpreted in an idealized or overly formal sense unless expressly so defined herein.

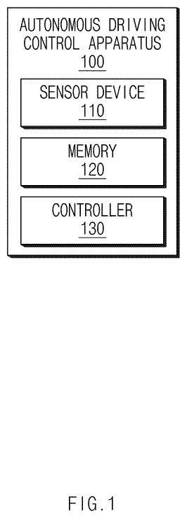

Hereinafter, embodiments of the present disclosure will be described in detail with reference to FIGS. 1 to 10.

FIG. 1 is a block diagram illustrating components of an autonomous driving control apparatus according to an embodiment of the present disclosure.

According to an embodiment, an autonomous driving control apparatus 100 may include at least one of a sensor device 110, a memory 120, or a controller 130, or any combination thereof. The components of the autonomous driving control apparatus 100, which are shown in FIG. 1, are illustrative, and embodiments of the present disclosure are not limited thereto. For example, the autonomous driving control apparatus 100 may further include components (e.g., at least one of an interface, a communication device, or a display, or any combination thereof) which are not shown in FIG. 1.

According to an embodiment, the sensor device 110 may obtain (or identify) various pieces of information used for driving of a host vehicle.

For example, the sensor device 110 may include at least one sensor including at least one of a camera, radio detection and ranging (RADAR), or light detection and ranging (LiDAR), or any combination thereof.

For example, the sensor 110 may include a first sensor and a second sensor.

As an example, the first sensor may identify a first lane detection result about an area including a forward direction of the host vehicle. As an example, the first sensor may include at least one first camera mounted on at least one area of a wind shield of the host vehicle. The at least one first camera may include, for example, a front view camera.

As an example, the second sensor may identify a second lane detection result about an area including a sideward direction of the host vehicle. As an example, the second sensor may include at least one second camera mounted on at least one area of a side mirror (or a side view camera) of the host vehicle. The at least one second camera may include, for example, a surround camera. The at least one second camera may identify the second lane detection result about the area including the sideward direction of the host vehicle by means of, for example, a fish eye lens.

For example, the sensor device 110 may obtain information about a lane in which the host vehicle is traveling.

As an example, the sensor device 110 may identify information about at least one line of the lane. The sensor device 110 may identify a lane detection result including at least one of a left line of the lane or a right line of the lane, or any combination thereof.

As an example, the sensor device 110 may obtain information using the at least one sensor and may identify information obtained based on other external components (e.g., a communication device).

According to an embodiment, the memory 120 may store a command or data. For example, the memory 120 may store one or more instructions, when executed by the controller 130, causing the autonomous driving control apparatus 100 to perform various operations.

For example, the memory 120 and the controller 130 may be implemented as one chipset. The controller 130 may include at least one of a communication processor or a modem.

For example, the memory 120 may store various pieces of information associated with the autonomous driving control apparatus 100. As an example, the memory 120 may store information about an operation history of the controller 130. As an example, the memory 120 may store information about states and/or operations of components (e.g., at least one of an engine control unit (ECU), the sensor device 110, or the controller 130, or any combination thereof) of the host vehicle.

According to an embodiment, the controller 130 may be operatively connected with the sensor device 110 and/or the memory 120. For example, the controller 130 may control operations of the sensor device 110 and/or the memory 120.

For example, the controller 130 may identify at least one lane detection result about the lane in which the host vehicle is traveling, using the sensor device 110.

For example, the controller 130 may identify the first lane detection result about an area including a forward direction of the host vehicle, using the first sensor included in the sensor device 110. As an example, the first sensor may include at least one first front view camera mounted on at least one area of the wind shield of the host vehicle.

For example, the controller 130 may identify the second lane detection result about an area including a sideward of a vehicle in front of the host vehicle, using the second sensor included in the sensor device 110. As an example, the second sensor may include at least one surround camera mounted on at least one area of the side mirror of the host vehicle.

For example, the controller 130 may generate a first driving route and a second driving route, based respectively on the first lane detection result and the second lane detection result.

As an example, each of the first lane detection result and the second lane detection result may include information about the lane, which is obtained using the first sensor and the second sensor. The information about the lane may include, for example, at least one of a curvature of the lane, a left line of the lane, a right line of the lane, a position of the host vehicle on the lane, a distance from the center of the host vehicle to the left line and the right line, a road surface state, or a gradient, or any combination thereof.

As an example, each of the first driving route and the second driving route may include a virtual driving route generated to correspond to the lane in which the host vehicle is traveling based on the first lane detection result and the second lane detection result.

For example, the controller 130 may generate a final driving route for autonomous driving control for the host vehicle, based on at least one of the first driving route or the second driving route, or any combination thereof. The final driving route may include, for example, a virtual driving route generated for driving of the host vehicle by the autonomous driving control apparatus 100. The controller 130 may generate the final driving route based on at least one of, for example, a similarity (or similarity value) between the first driving route and the second driving route, first reliability (or first reliability value) for the first driving route, or second reliability (or second reliability value) for the second driving route, or any combination thereof.

For example, the controller 130 may identify each of the first reliability of the first driving route and the second reliability of the second driving route. The controller 130 may determine a driving route to be used to generate the final driving route based on, for example, whether each reliability is greater than or equal to reference reliability, whether a line included in the first lane detection result and a line included in the second lane detection result are the same lines, or whether the similarity between the first driving route and the second driving route is greater than or equal to the reference reliability. The reference reliability and/or the reference similarity may be, for example, a setting value changeable by a developer and/or a user.

As an example, when the first reliability is greater than or equal to the reference reliability, the controller 130 may generate the final driving route based on the first driving route.

As an example, when the first reliability is less than the reference reliability and when the second reliability is greater than or equal to the reference reliability, the controller 130 may generate the final driving route based on the second driving route.

In other words, when the first reliability is greater than or equal to the reference reliability, the controller 130 may generate the final driving route using the first driving route regardless of a magnitude of the second reliability.

As an example, when a first line included in the first lane detection result corresponds to a line in an opposite direction to a second line included in the second lane detection result, the controller 130 may identify whether the first reliability and the second reliability are greater than or equal to the reference reliability.

When the first line and the second line are lines in opposite directions (e.g., when the first line is a left line of the lane and the second line is a right line of the lane) and when the first reliability and the second reliability are greater than or equal to the reference reliability, the controller 130 may identify a similarity between the first driving route and the second driving route.

When the identified similarity is greater than or equal to the reference similarity, for example, the controller 130 may generate the final driving route including information about the first line and the second line based on the first driving route and the second driving route. For example, the controller 130 may identify first virtual route information corresponding to the first line based on the first driving route, may identify second virtual route information corresponding to the second line based on the second driving route, and may generate the final driving route including the first virtual route information and the second virtual route information.

When the identified similarity is less than the reference similarity, the controller 130 may generate the final driving route including information about the first line and the second line based on a driving route with a low curvature between the first driving route and the second driving route. In other words, the controller 130 may generate the final driving route based on a driving route which is relatively close to a straight line between the first driving route and the second driving route. When the first driving route is lower in curvature than the second driving route, the controller 130 may generate a left line of the final driving route corresponding to the first line (e.g., the left line of the lane) based on the first driving route and may generate a right line of the final driving route corresponding to the second line based on pieces of information included in the first driving route.

When the first line and the second line are lines in opposite directions (e.g., when the first line is the left line of the lane and the second line is the right line of the lane), the controller 130 may generate the final driving route including the information about the first line and the second line based on a driving route corresponding to reliability with a higher value between the first reliability and the second reliability. For example, when the first reliability is greater than or equal to the reference reliability and when the second reliability is less than the reference reliability, the controller 130 may generate the final driving route based on the first driving route.

When the first line and the second line are lines in the same direction (e.g., when both the first line and the second line are left lines and right lines of the lane) and when the first reliability and the second reliability are greater than or equal to the reference reliability, the controller 130 may identify a similarity between the first driving route and the second driving route.

When the identified similarity is greater than or equal to the reference similarity, for example, the controller 130 may generate the final driving route including the information about the first line and the second line based on at least one piece of route information corresponding to the first driving route. For example, the at least one piece of route information may include at least one coefficient (e.g., a first equation coefficient and/or a second equation coefficient) included in an equation corresponding to the first driving route. For example, the controller 130 may identify a first equation and a second equation respectively corresponding to the first driving route and the second driving route. The controller 130 may identify at least one of, for example, a coefficient of the first equation and the second equation, or a coefficient of an equation obtained by differentiating the first equation and the second equation n times, or any combination thereof. The controller 130 may generate the final driving route including the information about the first line and the second line, based on, for example, an average value of coefficients associated with the first equation and coefficients associated with the second equation, which correspond to the coefficients associated with the first equation.

When the identified similarity is less than the reference similarity, the controller 130 may generate the final driving route including the information about the first line and the second line based on a driving route with a low curvature between the first driving route and the second driving route. In other words, the controller 130 may generate the final driving route based on a driving route which is relatively close to a straight line between the first driving route and the second driving route. When the first driving route is lower in curvature than the second driving route, the controller 130 may generate a left line of the final driving route corresponding to the first line (e.g., the left line of the lane) based on the first driving route and may generate a right line of the final driving route corresponding to the second line based on pieces of information included in the first driving route.

For example, the controller 130 may identify curvature information of the lane in which the host vehicle is traveling and/or the lane to be expected to travel, based on an estimated driving route of the host vehicle. As an example, the controller 130 may identify curvature information of the estimated driving route using navigation information and/or road traffic information obtained using a communication device (not shown).

As an example, the controller 130 may identify that the host vehicle is expected to enter a section with a curvature of a specified value or more based on the estimated driving route of the host vehicle. The controller 130 may identify at least one of, for example, an estimated remaining time until the host vehicle enters the section with the curvature of the specified value or more from the current location or an estimated remaining distance, or any combination thereof.

As an example, when identifying that the host vehicle is expected to enter the section with the curvature of the specified value or more and that the first reliability of the first driving route and the second reliability of the second driving route are greater than or equal to the reference reliability, based on the estimated driving route of the host vehicle, the controller 130 may control the host vehicle to travel based on the first driving route identified using the first sensor, before entering the section (e.g., when a specified distance or more is left and/or a specified time or more is left until the host vehicle enters the section). In other words, when identifying that a certain distance or more or a certain time or more is left until the host vehicle enters the section with the curvature of the specified value or more, the controller 130 may perform autonomous driving control for the host vehicle using the first sensor including the front view camera.

As an example, when identifying that the host vehicle enters the section with the curvature of the specified value or more, the controller 130 may determine data to be used to control the host vehicle to travel, based on sensing accuracy of the first sensor while the host vehicle enters the section. For example, when identifying that the accuracy of curvature information of the section included in the first lane detection result while the host vehicle enters the section has an error of a certain difference or more with curvature information obtained from the outside (e.g., navigation) (or when the accuracy of the curvature information of the section included in the first lane detection result is less than reference accuracy), the controller 130 may control the host vehicle to travel based on the second driving route identified using the second sensor. In other words, when identifying that sensing accuracy of the first sensor is less than the reference accuracy while the host vehicle enters the section with the curvature of the specified value or more, the controller 130 may perform autonomous driving control for the host vehicle using the second sensor including the surround camera.

As an example, when identifying that the host vehicle completes entering the section with the curvature of the specified value or more (or when the host vehicle deviates from the section or while the host vehicle is traveling in a section with a curvature of less than the specified value), the controller 130 may determine data to be used to control the host vehicle to travel, based on the magnitude of the similarity between the first driving route and the second driving route. For example, when identifying that the similarity meets a specified criterion (e.g., when identifying that the similarity is greater than or equal to the specified criterion), the controller 130 may generate the final driving route for autonomous driving control for the host vehicle based on the first driving route. In other words, when identifying that the host vehicle completes entering the section with the curvature of the specified value or more and identifying that the similarity between the driving routes identified using the first sensor and the second sensors is greater than or equal to the reference similarity, the controller 130 may perform autonomous driving control for the host vehicle using the first sensor including the front view camera.

For example, the controller 130 may generate the final driving route by means of at least one equation corresponding to the lane. For example, the controller 130 may identify a similarity between the first driving route and the second driving route, based on that a portion of a difference between at least one piece of information corresponding to the first driving route (e.g., a difference between the first equation coefficient and the second equation coefficient corresponding to the second driving route) is greater than a threshold, and may generate the final driving route based on magnitude of the similarity.

As an example, the controller 130 may identify a similarity between driving routes obtained using different sensors and may generate the final driving route for autonomous driving control of the host vehicle based on a magnitude of the similarity. An example of Equation 1 below, which corresponds to the lane identified by the controller 130, is as follows.

$$y = {ax}^{3} + {bx}^{2} + {cx}^{1} + d \qquad [ Equation 1 ]$$

For example, y may indicate the lateral error between the line when the longitudinal position of the host vehicle is x and the vehicle.

As an example, the controller 130 may identify at least one piece of route information (e.g., the first equation coefficient) corresponding to the first driving route and at least one piece of route information (e.g., the second equation coefficient) corresponding to the second driving route. At this time, the controller 130 may identify each of Equation 2 below, which is obtained by differentiating Equation 1 above, Equation 3 below, which is obtained by differentiating Equation 2 below, and Equation 4 below, which is obtained by differentiating Equation 3 below.

$${y}^{′} = 3 {ax}^{2} + 2 {bx}^{1} + c \qquad [ Equation 2 ]$$

$${y}^{″} = 6 {ax}^{2} + 2 b \qquad [ Equation 3 ]$$

$${y}^{′′′} = 6 a \qquad [ Equation 4 ]$$

For example, y′ according to Equation 2 above may indicate the heading error when the longitudinal position of the host vehicle is x.

For example, y″ according to Equation 3 above may indicate the curvature of the lane when the longitudinal position of the host vehicle is x.

For example, y″′ according to Equation 4 above may indicate the curvature change rate of the lane.

The controller 130 may identify a similarity between driving routes based on at least one of a coefficient a, b, or c of the equation, or any combination thereof. As an example, the controller 130 may identify a similarity between driving routes on the basis of the specific longitudinal position x of the host vehicle.

For example, the domain x of the equation may correspond to a control target point. The control target point may be, for example, a specific point expected that the host vehicle will travel and necessary for autonomous driving control. For convenience of description, a target point x_{tg} will be described below as an example.

For example, the controller 130 may identify the target point x_{tg} using Equation 5 below.

$${x}_{tg} = {V}_{x} * {T}_{ah} \qquad [ Equation 5 ]$$

For example, the controller 130 may use a driving speed Vₓ of the host vehicle and a look ahead time Tₐₕ to identify the target point (or the control target point) x_{tg}. The look ahead time Tₐₕ may be, for example, an estimated driving time required for the host vehicle to travel from a current location to the target point, but embodiments of the present disclosure are not limited thereto. The controller 130 may identify location information (e.g., longitudinal location information) of the control target point based on Equation 5 above.

For example, the controller 130 may identify a similarity between driving routes based on a difference between curvatures obtained using the first sensor and the second sensor and a difference between headings obtained using the first sensor and the second sensor, on the basis of the location information about the target point x_{tg}. A difference between respective parameters may be calculated based on Equations 6 and 7 below.

$$\vert y {1}^{′} ( {x}_{tg} ) - y {2}^{′} ( {x}_{tg} ) \vert < {θ}_{th} \qquad [ Equation 6 ]$$

$$\vert y {1}^{″} ( {x}_{tg} ) - y {2}^{″} ( {x}_{tg} ) \vert < {ρ}_{th} \qquad [ Equation 7 ]$$

For example, when an absolute value of a difference between values calculated on the basis of the target point x_{tg} using Equation 2 above is less than a curvature similarity determination boundary value (or a reference curvature difference) Θth as in Equation 6 above and when an absolute value of a difference between values calculated on the basis of the target point x_{tg} using Equation 3 above is less than a heading similarity determination boundary value (or a reference heading difference) ρth as in Equation 7 above, the controller 130 may identify that the similarity between the first driving route and the second driving route is greater than or equal to the reference similarity.

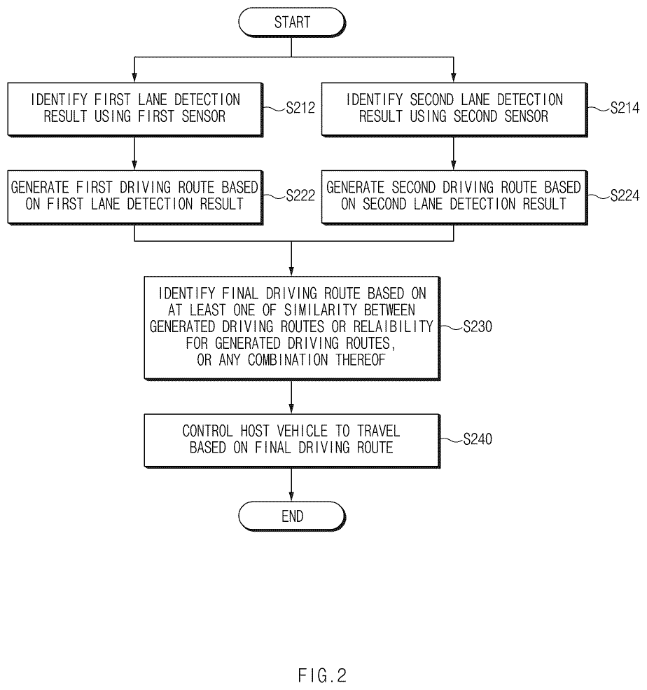

FIG. 2 is a flowchart of an autonomous driving control method according to an embodiment of the present disclosure.

According to an embodiment, an autonomous driving control apparatus (e.g., an autonomous driving control apparatus 100 of FIG. 1) may perform operations disclosed in FIG. 2. For example, at least some of components (e.g., a sensor device 110, a memory 120, and/or a controller 130 of FIG. 1) included in the autonomous driving control apparatus may be configured to perform the operations of FIG. 2.

Operations in S212 to S240 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 2, may be briefly described or omitted.

According to an embodiment, in S212, the autonomous driving control apparatus may identify a first lane detection result using a first sensor.

For example, the autonomous driving control apparatus may identify the first lane detection result about an area including a forward direction of a host vehicle, using the first sensor including at least one first camera mounted on at least one area of a wind shield of the host vehicle.

According to an embodiment, in S214, the autonomous driving control apparatus may identify a second lane detection result using a second sensor.

For example, the autonomous driving control apparatus may identify the second lane detection result about an area including a sideward direction of the host vehicle, using the second sensor including at least one second camera mounted on at least one area of a side mirror of the host vehicle.

According to an embodiment, in S222, the autonomous driving control apparatus may generate a first driving route based on the first lane detection result.

According to an embodiment, in S224, the autonomous driving control apparatus may generate a second driving route based on the second lane detection result.

According to an embodiment, in S230, the autonomous driving control apparatus may identify a final driving route based on at least one of a similarity between the generated driving routes or reliability for the generated driving routes, or any combination thereof.

According to an embodiment, in S240, the autonomous driving control apparatus may control the host vehicle to travel based on the final driving route.

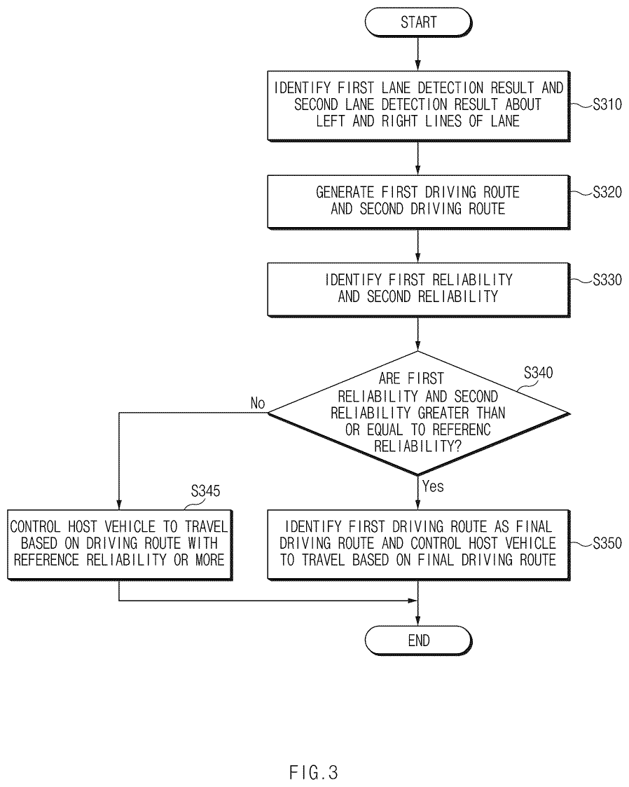

FIG. 3 is a flowchart of an autonomous driving control method according to an embodiment of the present disclosure.

According to an embodiment, an autonomous driving control apparatus (e.g., an autonomous driving control apparatus 100 of FIG. 1) may perform operations disclosed in FIG. 3. For example, at least some of components (e.g., a sensor device 110, a memory 120, and/or a controller 130 of FIG. 1) included in the autonomous driving control apparatus may be configured to perform the operations of FIG. 3.

Operations in S310 to S350 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 3, may be briefly described or omitted.

According to an embodiment, in S310, the autonomous driving control apparatus may identify a first lane detection result and a second lane detection result about left and right lines of the lane.

According to an embodiment, in S320, the autonomous driving control apparatus may generate a first driving route and a second driving route.

For example, the autonomous driving control apparatus may generate the first driving route based on the first lane detection result and may generate the second driving route based on the second lane detection result.

According to an embodiment, in S330, the autonomous driving control apparatus may identify first reliability and second reliability.

For example, the autonomous driving control apparatus may identify the first reliability for the first driving route and the second reliability for the second driving route.

For example, the autonomous driving control apparatus may identify an error between driving routes generated on the basis of reference data for a driving route (e.g., information about the driving route, which is received from the outside such as navigation or a communication device) and may identify reliability of each of the first driving route and the second driving route based on a magnitude of the error.

According to an embodiment, in S340, the autonomous driving control apparatus may identify whether the first reliability and the second reliability are greater than or equal to reference reliability.

For example, when it is determined that both the first reliability and the second reliability are greater than or equal to the reference reliability (e.g., S340-Yes), the autonomous driving control apparatus may perform S350.

For example, when it is determined that both the first reliability and the second reliability are not greater than or equal to the reference reliability (e.g., S340-No), the autonomous driving control apparatus may perform S345.

According to an embodiment, in S345, the autonomous driving control apparatus may control the host vehicle to travel based on the driving route with the reference reliability or more.

For example, the autonomous driving control apparatus may generate a final driving route using a driving route corresponding to reliability which is greater than or equal to the reference reliability between the first reliability and the second reliability and may perform autonomous driving control for the host vehicle based on the generated final driving route.

According to an embodiment, in S350, the autonomous driving control apparatus may identify the first driving route as the final driving route and may control the host vehicle to travel based on the final driving route.

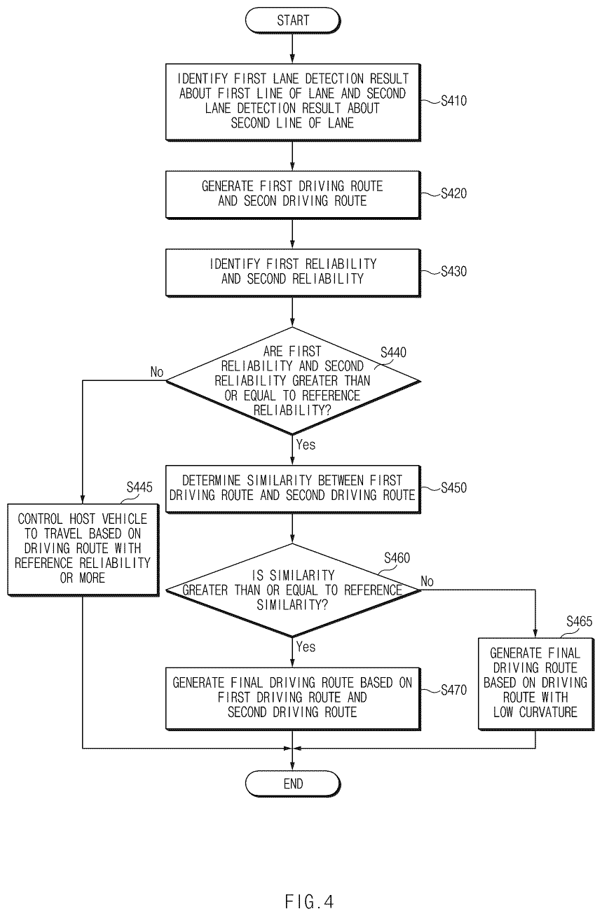

FIG. 4 is a flowchart of an autonomous driving control method according to an embodiment of the present disclosure.

According to an embodiment, an autonomous driving control apparatus (e.g., an autonomous driving control apparatus 100 of FIG. 1) may perform operations disclosed in FIG. 4. For example, at least some of components (e.g., a sensor device 110, a memory 120, and/or a controller 130 of FIG. 1) included in the autonomous driving control apparatus may be configured to perform the operations of FIG. 4.

Operations in S410 to S470 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 4, may be briefly described or omitted.

According to an embodiment, in S410, the autonomous driving control apparatus may identify a first lane detection result about a first line of the lane and a second lane detection result about a second line of the lane.

For example, the autonomous driving control apparatus may identify the first lane detection result and the second lane detection result respectively about the first line including a left line of the lane and the second line including a right line of the lane.

In other words, the autonomous driving control apparatus may identify information about lines respectively corresponding to opposite directions, using a first sensor and a second sensor.

According to an embodiment, in S420, the autonomous driving control apparatus may generate a first driving route and a second driving route.

For example, the autonomous driving control apparatus may generate the first driving route based on the first lane detection result and may generate the second driving route based on the second lane detection result.

According to an embodiment, in S430, the autonomous driving control apparatus may identify first reliability and second reliability.

For example, the autonomous driving control apparatus may identify the first reliability for the first driving route and the second reliability for the second driving route.

For example, the autonomous driving control apparatus may identify an error between driving routes generated on the basis of reference data for a driving route (e.g., information about the driving route, which is received from the outside such as navigation or a communication device) and may identify reliability of each of the first driving route and the second driving route based on a magnitude of the error.

According to an embodiment, in S440, the autonomous driving control apparatus may identify whether the first reliability and the second reliability are greater than or equal to reference reliability.

For example, when it is determined that both the first reliability and the second reliability are greater than or equal to the reference reliability (e.g., S440-Yes), the autonomous driving control apparatus may perform S450.

For example, when it is determined that both the first reliability and the second reliability are not greater than or equal to the reference reliability (e.g., S440-No), the autonomous driving control apparatus may perform S445.

According to an embodiment, in S445, the autonomous driving control apparatus may control the host vehicle to travel based on the driving route with the reference reliability or more.

For example, the autonomous driving control apparatus may generate a final driving route using a driving route corresponding to reliability which is greater than or equal to the reference reliability between the first reliability and the second reliability and may perform autonomous driving control for the host vehicle based on the generated final driving route.

According to an embodiment, in S450, the autonomous driving control apparatus may determine a similarity between the first driving route and the second driving route.

As For example, control may identify at least one piece of route information (e.g., a first equation coefficient) corresponding to the first driving route and at least one piece of route information (e.g., a second equation coefficient) corresponding to the second driving route and may identify the similarity between the first driving route and the second driving route based on whether a difference between the at least one piece of route information (e.g., a difference between the first equation coefficient and the at least one second equation coefficient) is greater than a threshold.

For example, the autonomous driving control apparatus may identify location information of a control target point, based on a driving vehicle speed of the host vehicle and an estimated driving time to the control target point, and may identify the similarity between the first driving route and the second driving route, based on at least one of a first curvature of the first driving route, a first heading of the first driving route, a second curvature of the second driving route, or a second heading of the second driving route, which is identified on the basis of the location information, or any combination thereof.

According to an embodiment, in S460, the autonomous driving control apparatus may determine whether the similarity is greater than or equal to reference similarity.

For example, when the difference between the first curvature and the second curvature is less than a reference curvature difference and when the difference between the first heading and the second heading is less than a reference heading difference, the autonomous driving control apparatus may determine that the similarity between the first driving route and the second driving route is greater than or equal to the reference similarity.

For example, when the similarity is greater than or equal to the reference similarity (e.g., S460-Yes), the autonomous driving control apparatus may perform S470.

For example, when the similarity is less than the reference similarity (e.g., S460-No), the autonomous driving control apparatus may perform S465.

According to an embodiment, in S465, the autonomous driving control apparatus may generator a final driving route based on that a driving route with a low curvature.

For example, the autonomous driving control apparatus may generate the final driving route based on the driving route with the low curvature (e.g., a driving route which is relatively close to a straight line) between the first driving route and the second driving route.

According to an embodiment, in S470, the autonomous driving control apparatus may generate the final driving route based on the first driving route and the second driving route.

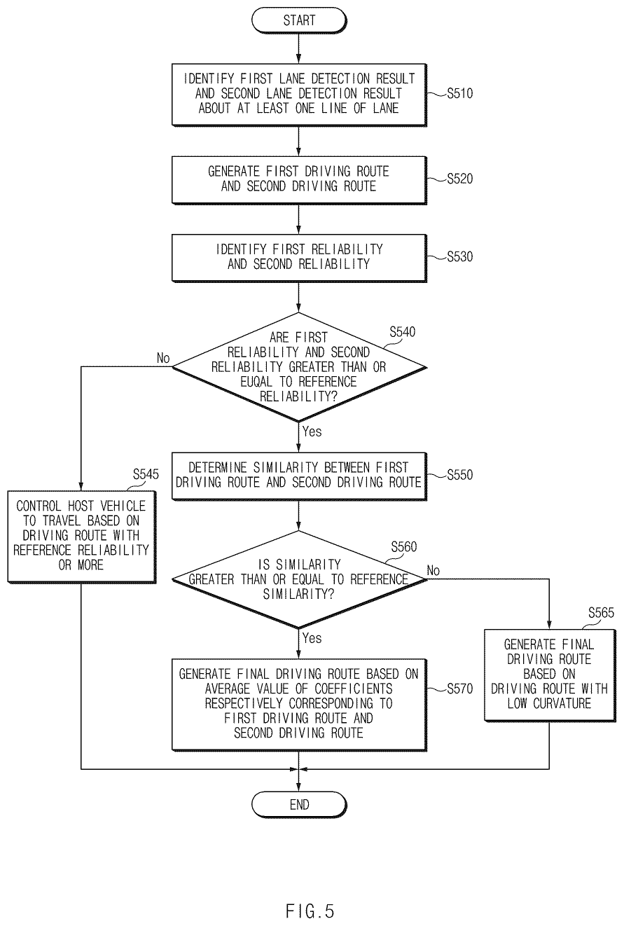

FIG. 5 is a flowchart of an autonomous driving control method according to an embodiment of the present disclosure.

According to an embodiment, an autonomous driving control apparatus (e.g., an autonomous driving control apparatus 100 of FIG. 1) may perform operations disclosed in FIG. 5. For example, at least some of components (e.g., a sensor device 110, a memory 120, and/or a controller 130 of FIG. 1) included in the autonomous driving control apparatus may be configured to perform the operations of FIG. 5.

Operations in S510 to S570 in an embodiment below may be sequentially performed, but are not necessarily sequentially performed. For example, an order of the respective operations may be changed, and at least two operations may be performed in parallel. For example, contents (e.g., contents of FIG. 4), which correspond to or are duplicated with the contents described above in conjunction with FIG. 5, may be briefly described or omitted.

According to an embodiment, in S510, the autonomous driving control apparatus may identify a first lane detection result about one line of the lane and a second lane detection result about a second line of the lane.

For example, the autonomous driving control apparatus may identify the first lane detection result and the second lane detection result about one of a left line or a right line of the lane.

In other words, the autonomous driving control apparatus may identify information about lines corresponding to the same direction, using a first sensor and a second sensor.

According to an embodiment, in S520, the autonomous driving control apparatus may generate a first driving route and a second driving route.

For example, the autonomous driving control apparatus may generate the first driving route based on the first lane detection result and may generate the second driving route based on the second lane detection result.

According to an embodiment, in S530, the autonomous driving control apparatus may identify first reliability and second reliability.

For example, the autonomous driving control apparatus may identify the first reliability for the first driving route and the second reliability for the second driving route.

For example, the autonomous driving control apparatus may identify an error between driving routes generated on the basis of reference data for a driving route (e.g., information about the driving route, which is received from the outside such as navigation or a communication device) and may identify reliability of each of the first driving route and the second driving route based on a magnitude of the error.

According to an embodiment, in S540, the autonomous driving control apparatus may identify whether the first reliability and the second reliability are greater than or equal to reference reliability.

For example, when it is determined that both the first reliability and the second reliability are greater than or equal to the reference reliability (e.g., S540-Yes), the autonomous driving control apparatus may perform S550.

For example, when it is determined that both the first reliability and the second reliability are not greater than or equal to the reference reliability (e.g., S540-No), the autonomous driving control apparatus may perform S545.

According to an embodiment, in S545, the autonomous driving control apparatus may control the host vehicle to travel based on the driving route with the reference reliability or more.

For example, the autonomous driving control apparatus may generate a final driving route using a driving route corresponding to reliability which is greater than or equal to the reference reliability between the first reliability and the second reliability and may perform autonomous driving control for the host vehicle based on the generated final driving route.

According to an embodiment, in S550, the autonomous driving control apparatus may determine a similarity between the first driving route and the second driving route.

For example, the autonomous driving control apparatus may identify at least one piece of route information (e.g., a first equation coefficient) corresponding to the first driving route and at least one piece of route information (e.g., a second equation coefficient) corresponding to the second driving route and may identify the similarity between the first driving route and the second driving route based on whether a difference between the at least one piece of route information (e.g., a difference between the first equation coefficient and the at least one second equation coefficient) is greater than a threshold.

For example, the autonomous driving control apparatus may identify location information of a control target point, based on a driving vehicle speed of the host vehicle and an estimated driving time to the control target point, and may identify the similarity between the first driving route and the second driving route, based on at least one of a first curvature of the first driving route, a first heading of the first driving route, a second curvature of the second driving route, or a second heading of the second driving route, which is identified on the basis of the location information, or any combination thereof.

According to an embodiment, in S560, the autonomous driving control apparatus may determine whether the similarity is greater than or equal to reference similarity.

For example, when a difference between the first curvature and the second curvature is less than a reference curvature difference and when a difference between the first heading and the second heading is less than the reference heading difference, the autonomous driving control apparatus may determine that the similarity between the first driving route and the second driving route is greater than or equal to the reference similarity.

For example, when the similarity is greater than or equal to the reference similarity (e.g., S560-Yes), the autonomous driving control apparatus may perform S570.

For example, when the similarity is less than the reference similarity (e.g., S560-No), the autonomous driving control apparatus may perform S565.

According to an embodiment, in S565, the autonomous driving control apparatus may generate a final driving route based on that a driving route with a low curvature.

For example, the autonomous driving control apparatus may generate the final driving route based on the driving route with the low curvature (e.g., a driving route which is relatively close to a straight line) between the first driving route and the second driving route.

According to an embodiment, in S570, the autonomous driving control apparatus may generate the final driving route based on at least one piece of route information respectively corresponding to the first driving route and the second driving route (e.g., an average value of coefficients of equations respectively corresponding to the first driving route and the second driving route).

For example, the coefficients may include at least one coefficient of an equation identified by the autonomous driving control apparatus in response to each of the first driving route and the second driving route. An example about the equation may be replaced with Equation 1 above of the description of FIG. 1, which is described above.

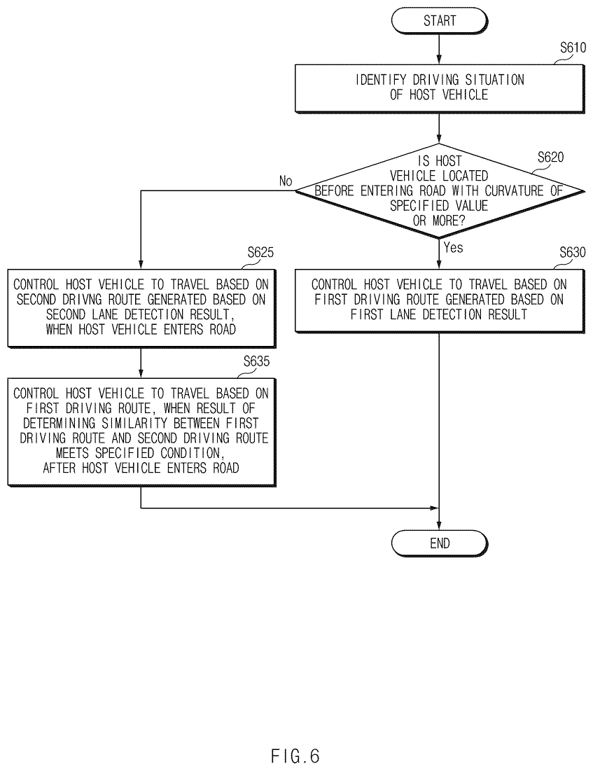

FIG. 6 is a flowchart of an autonomous driving control method according to an embodiment of the present disclosure.

According to an embodiment, an autonomous driving control apparatus (e.g., an autonomous driving control apparatus 100 of FIG. 1) may perform operations disclosed in FIG. 6. For example, at least some of components (e.g., a sensor device 110, a memory 120, and/or a controller 130 of FIG. 1) included in the autonomous driving control apparatus may be configured to perform the operations of FIG. 6.

Operations in S610 to S635 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 6, may be briefly described or omitted.

According to an embodiment, in S610, the autonomous driving control apparatus may identify a driving situation of a host vehicle.

For example, the autonomous driving control apparatus may identify information about at least one of a driving environment in which the host vehicle is traveling or driving information of the host vehicle, or any combination thereof, using a sensor device.

For example, the autonomous driving control apparatus may identify a driving situation including an estimated driving route of the host vehicle, based on navigation information and/or traffic information obtained using a communication device (e.g., traffic information obtained using vehicle-to-vehicle (V2V) communication and/or vehicle-to-everything (V2X) communication).

According to an embodiment, in S620, the autonomous driving control apparatus may identify whether the host vehicle is located before entering a lane (or a section) with a curvature of a specified value or more.

For example, the autonomous driving control apparatus may identify that the host vehicle is expected to enter the section with the curvature of the specified value or more and may identify whether a specified distance or more or specified time or more is left until the host vehicle enters the section, based on at least one of a real-time location of the host vehicle, traffic volume, or a driving speed of the host vehicle, or any combination thereof.

For example, when the host vehicle is located before entering the road with the curvature of the specified value or more (e.g., S620-Yes), the autonomous driving control apparatus may perform S630.

For example, when the host vehicle is not located before entering the road with the curvature of the specified value or more (e.g., S620-No) (e.g., when the host vehicle is traveling on the road (or the section) or when the host vehicle is located after entering the road), the autonomous driving control apparatus may perform S625.

According to an embodiment, in S625, the autonomous driving control apparatus may control the host vehicle to travel based on a second driving route generated based on a second lane detection result, when the host vehicle enters the road (or while the host vehicle enters the road).

For example, because the curvature of the road is relatively high, the autonomous driving control apparatus may control the host vehicle to travel based on the second driving route identified using the second sensor with the relatively high accuracy of identifying the curvature information.

According to an embodiment, in S630, the autonomous driving control apparatus may control the host vehicle to travel based on the first driving route generated based on the first lane detection result.

For example, because the host vehicle is located before entering the road, the autonomous driving control apparatus may determine that the host vehicle is traveling in a section with a relatively low curvature and may control the host vehicle to travel based on the first driving route identified using the first sensor with the relatively high accuracy of identifying a straight section.

According to an embodiment, after the host vehicle enters the road, when the result of determining a similarity between a first driving route and a second driving route meets a specified condition, in S635, the autonomous driving control apparatus may control the host vehicle to travel based on the first driving route.

For example, when it is determined that the similarity between the first driving route and the second driving route is greater than or equal to the reference similarity, the autonomous driving control apparatus may determine to perform driving control with high accuracy using only the identified result of the first sensor and may control the host vehicle to travel based on the first driving route.

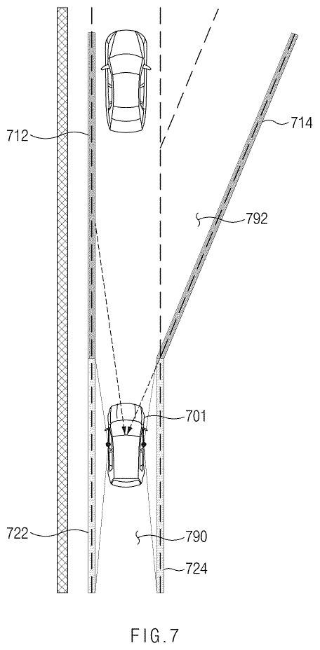

FIG. 7 is an operational conceptual diagram of an autonomous driving control apparatus according to an embodiment of the present disclosure.

According to an embodiment, an autonomous driving control apparatus (e.g., an autonomous driving control apparatus 100 of FIG. 1) may identify at least one lane detection result about a lane 790 in which a host vehicle 701 is traveling using a sensor device (e.g., a sensor device 110 of FIG. 1).

For example, the autonomous driving control apparatus may identify a first lane detection result about an area about a forward direction of the host vehicle 701, using a first sensor (e.g., a front view camera). The first lane detection result may include, for example, information about a first left line 712 and a first right line 714. The first right line 714 may be, for example, a right line of a diverging road 792 diverging from one point in front of the lane 790 in which the host vehicle 701 is traveling.

For example, the autonomous driving control apparatus may identify a second lane detection result about an area about a sideward direction of the host vehicle 701, using a second sensor (e.g., a surround camera). The second lane detection result may include, for example, information about a second left line 722 and a second right line 724.

In the situation shown in FIG. 7, the autonomous driving control apparatus may generate a first driving route and a second driving route respectively corresponding to the first lane detection result and the second lane detection result and may determine one driving route as a driving route for generating a final driving route on the basis of a similarity between driving routes.

For example, when the reliability of the first lane detection result or the second lane detection result is greater than or equal to reference reliability and when the similarity is less than the reference reliability, the autonomous driving control apparatus may generate a final driving route including information about the left line and the right line of the lane 790 based on a driving route with a low curvature (e.g., the second driving route generated based on the second lane detection result, according to FIG. 7) between the first driving route and the second driving route.

As a result, the autonomous driving control apparatus may improve accuracy for autonomous driving control of the host vehicle 701 and may minimize a possibility of occurrence of error control.

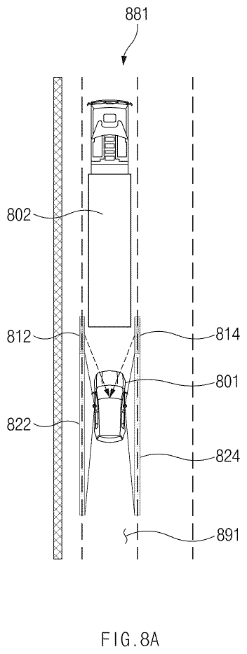

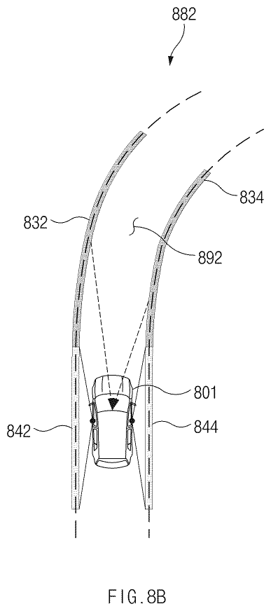

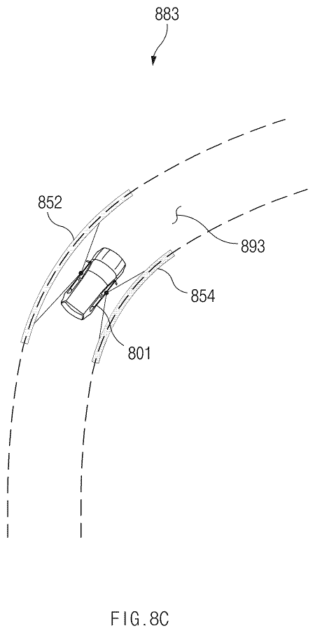

FIGS. 8A to 8C are operational conceptual diagrams of an autonomous driving control apparatus according to an embodiment of the present disclosure.

Referring to reference numeral 881 of FIG. 8A, according to an embodiment, an autonomous driving control apparatus (e.g., an autonomous driving control apparatus 100 of FIG. 1) may obtain information about a first lane 891 using a sensor device (e.g., a sensor device 110 of FIG. 1) in a situation where there is another vehicle 802 in front of a host vehicle 801.

For example, the autonomous driving control apparatus may identify a first lane detection result about an area about a forward direction of the host vehicle 801, using a first sensor (e.g., a front view camera). The first lane detection result may include, for example, information about a first left line 812 and a first right line 814.

For example, the autonomous driving control apparatus may identify a second lane detection result about an area about a sideward direction of the host vehicle 801, using a second sensor (e.g., a surround camera). The second lane detection result may include, for example, information about a second left line 822 and a second right line 824.

In a situation according to reference numeral 881, the first lane detection result may include data which is somewhat inaccurate or insufficient due to the other vehicle 802. In this case, the autonomous driving control apparatus may control the host vehicle 801 to travel based on a second driving route generated based on the second lane detection result.

Referring to reference numeral 882 of FIG. 8B, according to an embodiment, the autonomous driving control apparatus may identify that the host vehicle 801 is expected to enter a second lane 892 (or section) with a curvature of a specified value or more.

For example, the autonomous driving control apparatus may identify a first lane detection result about an area including a forward direction of the host vehicle 801 using the first sensor. The first lane detection result may include, for example, information about a third left line 832 and a third right line 834.

For example, the autonomous driving control apparatus may identify a second lane detection result about an area including a sideward direction of the host vehicle 801, using the second sensor. The second lane detection result may include, for example, information about a fourth left line 842 and a fourth right line 844.

In a situation according to reference numeral 882, when first reliability and second reliability respectively corresponding to the first lane detection result and the second lane detection result are greater than or equal to reference reliability, the autonomous driving control apparatus may control the host vehicle 801 to travel based on the first lane detection result. In other words, the autonomous driving control apparatus may perform autonomous driving control of the host vehicle 801 using the first sensor including a front view camera before the host vehicle 801 enters a high-curvature section (e.g., a second lane 892).

Referring to reference numeral 883 of FIG. 8C, according to an embodiment, the autonomous driving control apparatus may identify that the host vehicle 801 enters a third lane 893 (or section) with a curvature of a specified value or more.

For example, because the curvature of the third lane 893 is greater than or equal to the specified value, the autonomous driving control apparatus may fail to identify the first lane detection result about the area including the forward direction of the host vehicle 801 using the first sensor.

For example, the autonomous driving control apparatus may identify the second lane detection result about the area including the sideward direction of the host vehicle 801, using the second sensor. The second lane detection result may include, for example, information about a fifth left line 852 and a fifth right line 854.

In a situation according to reference numeral 883, when the accuracy of curvature information included in the first lane detection result is less than reference reliability (or when first reliability of the first lane detection result is less than reference reliability), the autonomous driving control apparatus may control the host vehicle 801 to travel based on the second lane detection result. In other words, the autonomous driving control apparatus may perform autonomous driving control of the host vehicle 801 using the second sensor including a surround camera while the host vehicle 801 enters a high-curvature section (e.g., a third lane 893).

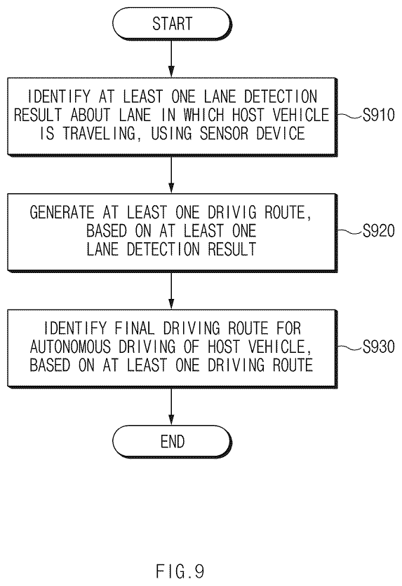

FIG. 9 is a flowchart of an autonomous driving control method according to an embodiment of the present disclosure.

According to an embodiment, an autonomous driving control apparatus (e.g., an autonomous driving control apparatus 100 of FIG. 1) may perform operations disclosed in FIG. 9. For example, at least some of components (e.g., a sensor device 110, a memory 120, and/or a controller 130 of FIG. 1) included in the autonomous driving control apparatus may be configured to perform the operations of FIG. 9.

Operations in S910 to S930 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 9, may be briefly described or omitted.

According to an embodiment, in S910, the autonomous driving control apparatus may identify at least one lane detection result about a lane in which a host vehicle is traveling, using a sensor device.

For example, the autonomous driving control apparatus may identify each of a first lane detection result and a second lane detection result about the lane, respectively using a first sensor including a front view camera and a second sensor including a surround camera.

According to an embodiment, in S920, the autonomous driving control apparatus may generate at least one driving route, based on at least one lane detection result.

For example, the autonomous driving control apparatus may generate a first driving route and a second driving route, based respectively on the first lane detection result and the second lane detection result.

According to an embodiment, in S930, the autonomous driving control apparatus may identify a final driving route for autonomous driving of the host vehicle, based on the at least one driving route.

For example, the autonomous driving control apparatus may generate a final driving route based on at least one of a similarity between the first driving route and the second driving route, first reliability for the first driving route, or second reliability for the second driving route, or any combination thereof.

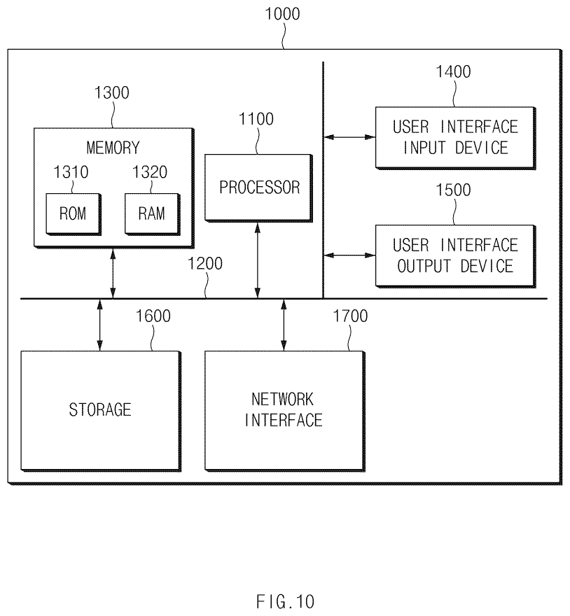

FIG. 10 illustrates a computing system about an autonomous driving control method according to an embodiment of the present disclosure.

Referring to FIG. 10, a computing system 1000 about the autonomous driving control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the autonomous driving control apparatus and the method thereof according to an embodiment of the present disclosure.

According to at least one of embodiments of the present disclosure, the autonomous driving control apparatus may generate a driving route for autonomous driving control using a type of each of sensors of a host vehicle, reliability, and a similarity between pieces of information obtained by means of sensors.

Furthermore, according to at least one of embodiments of the present disclosure, the autonomous driving control apparatus may previously identify a situation in which a sensing result of a specific sensor is relatively degraded in accuracy and may determine whether to use the sensing result of the sensor based on the identified situation, thus increasing the accuracy of autonomous driving control.

Furthermore, according to at least one of embodiments of the present disclosure, the autonomous driving control apparatus may divide a situation before the host vehicle enters a section with a relatively high curvature, a situation while the host vehicle enters the section, and a situation after the host vehicle enters the section, in a situation where the host vehicle should travel in the section, and may selectively use sensing data for generating a driving route, thus performing autonomous driving control which is more accurate and has higher stability.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An autonomous driving control apparatus, comprising:
a sensor device including a first sensor and a second sensor different from the first sensor;
a memory storing at least one instruction; and
a controller operatively connected with the sensor device and the memory,
wherein the at least one instruction is configured to, when executed by the controller, cause the autonomous driving control apparatus to:
determine at least one lane detection result regarding a lane in which a host vehicle is traveling, using at least one of the first sensor or the second sensor, or any combination thereof;
generate at least one driving route, based on the at least one lane detection result; and
determine a final driving route for autonomous driving of the host vehicle, based on the at least one driving route.

2. The autonomous driving control apparatus of claim 1, wherein the sensor device includes:
the first sensor configured to determine a first lane detection result about an area including a forward direction of the host vehicle and include at least one first camera mounted on at least one area of a wind shield of the host vehicle; and
the second sensor configured to determine a second lane detection result about an area including a sideward direction of the host vehicle and include at least one second camera mounted on at least one area of a side mirror of the host vehicle.

3. The autonomous driving control apparatus of claim 1, wherein the at least one instruction is configured to, when executed by the controller, cause the autonomous driving control apparatus to:
determine the first lane detection result using the first sensor and determine the second lane detection result using the second sensor;
generate a first driving route and a second driving route, based respectively on the first lane detection result and the second lane detection result; and
generate the final driving route based on at least one of a similarity value between the first driving route and the second driving route, first reliability value for the first driving route, or second reliability value for the second driving route, or any combination thereof.

4. The autonomous driving control apparatus of claim 3, wherein the at least one instruction is configured to, when executed by the controller, cause the autonomous driving control apparatus to:
determine the first reliability value of the first driving route and the second reliability value of the second driving route;
generate the final driving route based on the first driving route, when the first reliability value is greater than or equal to reference reliability value; and
generate the final driving route based on the second driving route, when the first reliability value is less than the reference reliability value and when the second reliability value is greater than or equal to the reference reliability value.

5. The autonomous driving control apparatus of claim 3, wherein the at least one instruction is configured to, when executed by the controller, cause the autonomous driving control apparatus to:
when a first line included in the first lane detection result corresponds to a line in an opposite direction to a second line included in the second lane detection result:
determine the first reliability value of the first driving route and the second reliability value of the second driving route;
determine a similarity value between the first driving route and the second driving route, when the first reliability value and the second reliability value are greater than or equal to reference reliability value; and
generate the final driving route including information about the first line and the second line based on the first driving route and the second driving route, when the similarity value is greater than or equal to the reference similarity value.

6. The autonomous driving control apparatus of claim 3, wherein the at least one instruction is configured to, when executed by the controller, cause the autonomous driving control apparatus to:
when a first line included in the first lane detection result corresponds to a line in an opposite direction to a second line included in the second lane detection result:
determine the first reliability value of the first driving route and the second reliability value of the second driving route;
determine a similarity value between the first driving route and the second driving route, when the first reliability value and the second reliability value are greater than or equal to reference reliability value; and
generate the final driving route including information about the first line and the second line based on a driving route with a low curvature between the first driving route and the second driving route, when the similarity value is less than the reference similarity value.

7. The autonomous driving control apparatus of claim 3, wherein the at least one instruction is configured to, when executed by the controller, cause the autonomous driving control apparatus to:
when a first line included in the first lane detection result corresponds to a line in an opposite direction to a second line included in the second lane detection result:
determine the first reliability value of the first driving route and the second reliability value of the second driving route; and
generate the final driving route including information about the first line and the second line based on a driving route corresponding to reliability value with a higher value between the first reliability value and the second reliability value.

8. The autonomous driving control apparatus of claim 3, wherein the at least one instruction is configured to, when executed by the controller, cause the autonomous driving control apparatus to:
when a first line included in the first lane detection result corresponds to a line in the same direction as a second line included in the second lane detection result:
determine the first reliability value of the first driving route and the second reliability value of the second driving route;
determine a similarity value between the first driving route and the second driving route, when the first reliability value and the second reliability value are greater than or equal to reference reliability value; and
generate the final driving route including information about the first line and the second line based on at least one piece of route information corresponding to the first driving route, when the similarity value is greater than or equal to the reference similarity value.

9. The autonomous driving control apparatus of claim 3, wherein the at least one instruction is configured to, when executed by the controller, cause the autonomous driving control apparatus to:
when a first line included in the first lane detection result corresponds to a line in the same direction as a second line included in the second lane detection result:
determine the first reliability value of the first driving route and the second reliability value of the second driving route;
determine a similarity value between the first driving route and the second driving route, when the first reliability value and the second reliability value are greater than or equal to reference reliability value; and
generate the final driving route including information about the first line and the second line based on a driving route with a low curvature between the first driving route and the second driving route, when the similarity value is less than the reference similarity value.

10. The autonomous driving control apparatus of claim 3, wherein the at least one instruction is configured to, when executed by the controller, cause the autonomous driving control apparatus to:
control the host vehicle to travel based on the first driving route identified using the first sensor, before the host vehicle enters a section with a curvature of a specified value or more, when determining that the host vehicle is expected to enter the section and that the first reliability value of the first driving route and the second reliability value of the second driving route are greater than or equal to reference reliability value, based on an estimated driving route of the host vehicle.

11. The autonomous driving control apparatus of claim 10, wherein the at least one instruction is configured to, when executed by the controller, cause the autonomous driving control apparatus to:
control the host vehicle to travel based on the second driving route when accuracy of curvature information included in the first lane detection result is less than reference accuracy, while the host vehicle enters the section.

12. The autonomous driving control apparatus of claim 10, wherein the at least one instruction is configured to, when executed by the controller, cause the autonomous driving control apparatus to:
determine the similarity value between the first driving route and the second driving route, after the host vehicle completes entering the section; and
generate the final driving route based on the first driving route, when the similarity value meets a specified criterion.

13. The autonomous driving control apparatus of claim 2, wherein the at least one instruction is configured to, when executed by the controller, cause the autonomous driving control apparatus to:
generate a first driving route and a second driving route, based respectively on the first lane detection result and the second lane detection result;
determine at least one piece of route information corresponding to the first driving route;
determine a similarity value between the first driving route and the second driving route based on whether a difference between the at least one piece of route information is greater than a threshold; and
generate the final driving route based further on the similarity value.

14. The autonomous driving control apparatus of claim 13, wherein the at least one instruction is configured to, when executed by the controller, cause the autonomous driving control apparatus to:
determine location information of a control target point, based on a driving vehicle speed of the host vehicle and an estimated driving time to the control target point; and
determine the similarity value between the first driving route and the second driving route, based on at least one of a first curvature of the first driving route, a first heading of the first driving route, a second curvature of the second driving route, or a second heading of the second driving route, or any combination thereof, the first curvature, the first heading, the second curvature, and the second heading being identified on the basis of the location information.

15. The autonomous driving control apparatus of claim 14, wherein the at least one instruction is configured to, when executed by the controller, cause the autonomous driving control apparatus to:
determine that the similarity value between the first driving route and the second driving route is greater than or equal to reference similarity value, when a difference between the first curvature and the second curvature is less than a reference curvature difference and when a difference between the first heading and the second heading is less than a reference heading difference.

16. An autonomous driving control method, comprising:
determining, by a controller, at least one lane detection result regarding a lane in which a host vehicle is traveling, using at least one of a first sensor included in a sensor device or a second sensor included in the sensor device, or any combination thereof;
generating, by the controller, at least one driving route, based on the at least one lane detection result; and
determining, by the controller, a final driving route for autonomous driving of the host vehicle, based on the at least one driving route.

17. The autonomous driving control method of claim 16, further comprising:
generating, by the controller, a first driving route based on a first lane detection result identified using the first sensor and generating, by the controller, a second driving route based on a second lane detection result identified using the second sensor;
determining, by the controller, first reliability value of the first driving route and second reliability value of the second driving route;
generating, by the controller, the final driving route based on the first driving route, when the first reliability value is greater than or equal to reference reliability value; and
generating, by the controller, the final driving route based on the second driving route, when the first reliability value is less than the reference reliability value and when the second reliability value is greater than or equal to the reference reliability value.

18. The autonomous driving control method of claim 16, further comprising:
generating, by the controller, a first driving route based on a first lane detection result identified using the first sensor and generating, by the controller, a second driving route based on a second lane detection result identified using the second sensor;
determining, by the controller, first reliability value of the first driving route and second reliability value of the second driving route, when a first line included in the first lane detection result corresponds to a line in an opposite direction to a second line included in the second lane detection result;
determining, by the controller, a similarity value between the first driving route and the second driving route, when the first reliability value and the second reliability value are greater than or equal to reference reliability value; and
generating, by the controller, the final driving route including information about the first line and the second line based on a driving route with a low curvature between the first driving route and the second driving route, when the similarity value is less than the reference similarity value.

19. The autonomous driving control method of claim 16, further comprising:
generating, by the controller, a first driving route based on a first lane detection result identified using the first sensor and generating, by the controller, a second driving route based on a second lane detection result identified using the second sensor;
determining, by the controller, first reliability value of the first driving route and second reliability value of the second driving route, when a first line included in the first lane detection result corresponds to a line in the same direction as a second line included in the second lane detection result;
determining, by the controller, a similarity value between the first driving route and the second driving route, when the first reliability value and the second reliability value are greater than or equal to reference reliability value; and
generating the final driving route including information about the first line and the second line based on a driving route with a low curvature between the first driving route and the second driving route, when the similarity value is less than the reference similarity value.

20. The autonomous driving control method of claim 16, further comprising:
generating, by the controller, a first driving route based on a first lane detection result identified using the first sensor and generating, by the controller, a second driving route based on a second lane detection result identified using the second sensor; and
when determining, by the controller, that the host vehicle is expected to enter a section with a curvature of a specified value or more and that first reliability value of the first driving route and second reliability value of the second driving route are greater than or equal to reference reliability value, based on an expected driving route of the host vehicle:
controlling, by the controller, the host vehicle to travel based on the first driving route identified using the first sensor, before the host vehicle enters the section;
controlling, by the controller, the host vehicle to travel based on the second driving route, when accuracy of curvature information included in the first lane detection result is less than reference accuracy, while the host vehicle enters the section; and
determining, by the controller, a similarity value between the first driving route and the second driving route, after the host vehicle completes entering the section, and generating, by the controller, the final driving route based on the first driving route, when the similarity value meets specified criterion.
